(19) United States
(12) Patent Application Publication
(10) Pub. No.: US 2022/0383071 A1
(43) Pub. Date: Dec. 1, 2022

(54) METHOD, APPARATUS, AND NON-TRANSITORY COMPUTER READABLE MEDIUM FOR OPTIMIZING GENERATIVE ADVERSARIAL NETWORK

(71) Applicant: HON HAI PRECISION INDUSTRY CO., LTD., New Taipei (TW)

(72) Inventors: GUO-CHIN SUN, New Taipei (TW); CHIN-PIN KUO, New Taipei (TW); CHUNG-YU WU, New Taipei (TW)

(21) Appl. No.: 17/746,198

(22) Filed: May 17, 2022

(30) Foreign Application Priority Data
May 19, 2021 (CN) 202110546995.1

(51) Int. Cl. G06N 3/04; G06V 10/82; G06V 10/776

(52) U.S. Cl. CPC G06N 3/0454; G06V 10/82; G06V 10/776

(57) ABSTRACT

A method, apparatus, and non-transitory computer readable medium for optimizing generative adversarial network includes determining a first weight of a generator and an equal second weight of a discriminator the first weight is configured to indicate a learning ability of the generator, the second weight is configured to indicate a learning ability of the discriminator; and alternative iteratively training the generator and the discriminator until the generator and the discriminator are convergent.

### CROSS-REFERENCE TO RELATED APPLICATIONS

This application claims priority to Chinese Patent Application No. 202110546995.1 filed on May 19, 2021 in the China National Intellectual Property Administration, the contents of which are incorporated by reference herein.

### FIELD

The subject matter herein generally relates to generative adversarial networks technology field, and particularly to a method, an apparatus, and a non-transitory computer readable medium for optimizing generative adversarial network.

### BACKGROUND

Generative adversarial network (GAN) normally includes a generator and a discriminator. The generator and the discriminator process an adversarial training and the generator generates samples that obey real data distribution. During the training, the generator generates sample images according to inputted random noise, aiming to generate real images to cheat the discriminator. The discriminator studies and determines a true or false state of the sample images, aiming to identify real sample images and the sample images generated by the generator. However, a free training of GAN may give rise to instability and thus abnormal adversarial training of the generator and the discriminator, which may cause mode collapse and a low diversity of the sample images.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows at least one embodiment of a schematic diagram of a generative adversarial network of the present disclosure.

FIG. 2 shows at least one embodiment of a schematic diagram of a neural network of the present disclosure.

FIG. 3 is a flowchart of at least one embodiment of a method for optimizing a generative adversarial network.

FIG. 4 shows at least one embodiment of a schematic structural diagram of an apparatus applying the method of the present disclosure.

### DETAILED DESCRIPTION

In order to provide a clear understanding of the objects, features, and advantages of the present disclosure, the same are given with reference to the drawings and specific embodiments. It should be noted that non-conflicting embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art as generally understood. The terms used in the present disclosure are for the purposes of describing particular embodiments and are not intended to limit the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

A generative adversarial network (GAN) is normally used to augment data, when it is difficult to collect sample data. Through training a small amount of sample data, a great amount of sample data can be generated. However, vanishing gradient, unstable training, and slow rate of convergence may occur during the training of the GAN. Unstable training may easily cause mode collapse and a low diversity of the sample data in the GAN.

A method, an apparatus, and a non-transitory computer readable medium for optimizing generative adversarial network are provided in the present disclosure for balancing losses between a generator and a discriminator, thereby the generator and the discriminator having a same learning ability for improving a stability of the GAN.

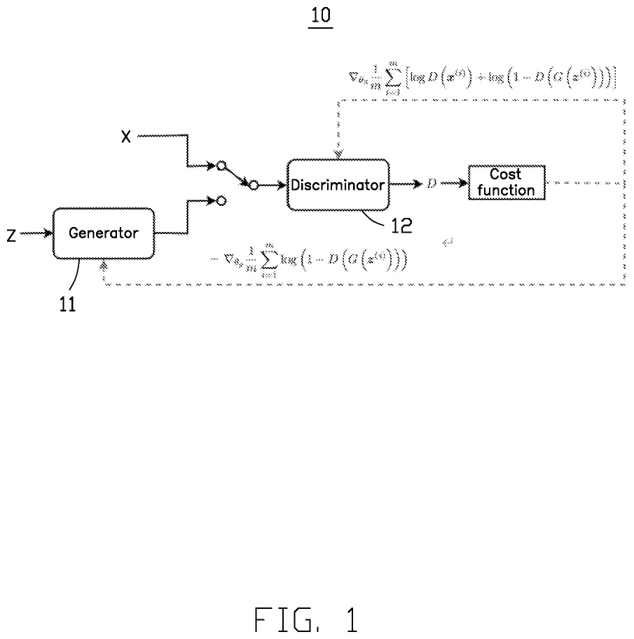

FIG. 1 shows at least one embodiment of a schematic diagram of a generative adversarial network (GAN) 10. The GAN 10 includes a generator 11 and a discriminator 12. The generator 11 is configured to receive noise sample z, generate a first image, obtain a second image from a data sample x, and further transmit the first image and the second image to the discriminator 12. The discriminator 12 is configured to receive the first image and the second image and output a determination of probability D being true or false. A value of the probability D may be [0, 1], wherein 1 indicates the determination result is true, 0 indicates the determination result is false.

In at least one embodiment, the generator 11 and the discriminator 12 are both neural networks. The neural network may include but is not limited to convolutional neural networks (CNN), recurrent neural network (RNN), deep neural networks (DNN), etc.

During a training of the GAN 10, the generator 11 and the discriminator 12 alternate in iterative training, and optimize each network through each cost function or loss function. For instance, when training the generator 11, a weight of the discriminator 12 must be fixed, and updated. When training the discriminator 12, a weight of the generator 11 must be fixed, and updated. The generator 11 and the discriminator 12 are strongly optimized in each network respectively, to form competitive adversary until reaching a dynamic balance therebetween, that is the Nash equilibrium. Therefore, the first image generated by the generator 11 is same as the second image obtained from the data sample x, when the discriminator 12 cannot determine truth or falsity between the first image and the second image, then 0.5 is output as probability D.

In at least one embodiment, the weight means a weight quantity of the neural network and indicates a learning ability of the neural network. The learning ability and the weight are in positive correlation.

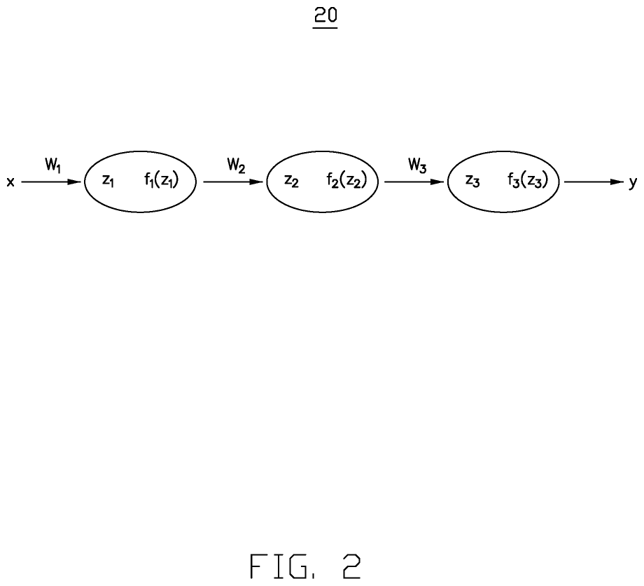

FIG. 2 illustrates at least one embodiment of a schematic diagram of a neural network 20. A learning process of the neural network 20 includes a signal forward propagation and an error counter propagation. During the signal forward propagation, the data sample x is inputted from an input layer, processed by a hidden layer, and outputted to an output layer. If an output y of the output layer does not correspond to an expected output, error counter propagation takes place. In the error counter propagation, an output error to the input layer through the hidden layer in counter propagation is processed in some form, and the error is apportioned to all neural cells of each layer, thus obtaining an error signal of the neural cells of each layer. The error signal can be regarded as an example for correcting weight W.

In at least one embodiment, the neural network includes an input layer, a hidden layer, and an output layer. The input layer is configured to receive external data of the neural network. The output layer is configured to output a calculation result of the neural network. Other parts of the neural network besides the input layer and the output layer are regarded as the hidden layer. The hidden layer is configured to abstract characteristics of the input data to another dimension, so as to classify the data linearly.

An output y of the neural network 20 may be as formula (1):

y=f₃(W₃*f₂(W₂*f₁(W₁*x))) (1)

Wherein x means data sample; f₁(z₁), f₂(z₂), f₃(z₃) means activation functions of z₁, z₂, z₃ inputted by the hidden layer, and W1, W2, W3 mean weights between layers.

Updating weight W in following formula (2) by gradient descent algorithm:

$${W}^{+} = W - η \frac{\partial Loss}{\partial W} \qquad ( 2 )$$

Wherein W⁺ means an updated weight, W means a weight before updating, Loss means a loss function, and η means a learning ratio, that is, an update range of the weight W.

In at least one embodiment, the loss function is configured to measure an ability of the discriminator 12 in generating images. The smaller the loss function is, the better is the performance of the discriminator 12 for identifying images generated by the generator 11 being in the present iteration; and vice versa.

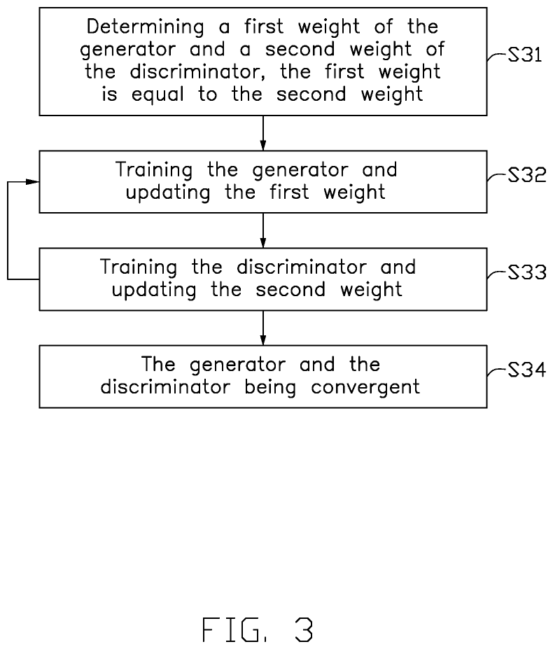

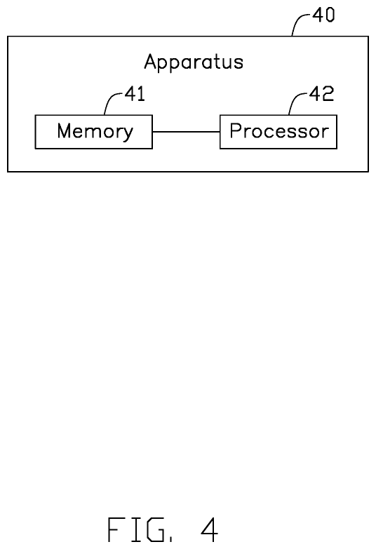

FIG. 3 illustrates a flowchart of at least one embodiment of a method for optimizing generative adversarial network of the present disclosure. The method is applied to one or more apparatus. The apparatus is a device capable of automatically performing numerical calculation and/or information processing according to an instruction set or having instruction set stored in advance, and the hardware thereof includes but is not limited to a processor, an external storage medium, a memory, or the like. The method is applicable to an apparatus 40 (shown in FIG. 4) for optimizing generative adversarial network.

In at least one embodiment, the apparatus 40 may be, but is not limited to, a desktop computer, a notebook computer, a cloud server, a smart phone, and the like. The apparatus can interact with the user through a keyboard, a mouse, a remote controller, a touch panel, a gesture recognition device, a voice control device, and the like.

Referring to FIG. 3, the method is provided by way of example, as there are a variety of ways to carry out the method. Each block shown in FIG. 3 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S31.

At block S31, determining a first weight of the generator and a second weight of the discriminator, the first weight is equal to the second weight.

In at least one embodiment, a method for determining the first weight and the second weight may include Xavier initialization, Kaiming initialization, Fixup initialization, LSUV initialization, and/or transfer learning, etc.

The first weight being equal to the second weight means that the generator and the discriminator have same learning ability.

At block S32, training the generator and updating the first weight.

The updating of the first weight is related to a learning ratio and the loss function of the generator, the learning ratio is dynamically set according to training times. The loss function L_{g} may be as formula (3):

$${L}_{g} = - {∇}_{{θ}_{g}} \frac{1}{m} {\sum }_{i = 1}^{m} log ( 1 - D ( G ( {z}^{( i )} ) ) ) \qquad ( 3 )$$

Wherein m means a quantity of the noise sample z; z⁽ⁱ⁾ means an ith noise sample; G(z⁽ⁱ⁾) means an image generated through the noise sample z⁽ⁱ⁾; D(G(z⁽ⁱ⁾)) means a probability of determining the image as true, and θ_{g} means the first weight.

A target of the generator is maximizing the loss function L_{g} to match generated sample distribution to real sample distribution.

At block S33, training the discriminator and updating the second weight.

The updating of the second weight is related to the learning ratio and the loss function of the discriminator, the learning ratio is dynamically set according to training times. The loss function L_{d} may be as formula (4):

$${L}_{d} = {∇}_{{θ}_{d}} \frac{1}{m} {\sum }_{i = 1}^{m} [ log D ( {x}^{( i )} ) + log ( 1 - D ( G ( {z}^{( i )} ) ) ) ] \qquad ( 4 )$$

Wherein x⁽ⁱ⁾ means an ith real image; D(x⁽ⁱ⁾) means a probability of determining the real image x⁽ⁱ⁾ being true and θ_{d} means the second weight.

A target of the generator is minimizing the loss function L_{d} to determine whether the input sample is a real image or an image generated by the generator.

At block S34, repeating blocks S32 and S33 until the generator and the discriminator are convergent.

In at least one embodiment, a sequence of blocks S32 and S33 is not limited, that is, in the alternating iterative training process of the generator and the discriminator, training the generator may be processed prior to training the discriminator.

In at least one embodiment, iteratively updating the first weight θ_{g} and the second weight θ_{d} by gradient descent, dynamically adjusting the learning ratio of the generator and the discriminator according to extension of the training period, until the loss function L_{g} of the generator and the loss function L_{d} of the discriminator are convergent, so as to obtain an optimal weight.

FIG. 4 shows at least one embodiment of an apparatus 40 including a memory 41 and at least one processor 42. The memory 41 stores instructions in the form of one or more computer-readable programs that can be stored in the non-transitory computer-readable medium (e.g., the storage device of the apparatus), and executed by the at least one processor of the apparatus to implement the method for optimizing generative adversarial network.

In at least one embodiment, the at least one processor 42 may be a central processing unit (CPU), and may also include other general-purpose processors, digital signal processors (DSPs), application specific integrated circuits (ASICs), and off-the-shelf programmable gate arrays, Field-Programmable Gate Array (FPGA) or other programmable logic device, discrete gate, or transistor logic device, discrete hardware components, etc. The general-purpose processor may be a microprocessor or the processor may be any conventional processor or the like. The at least one processor 42 is the control center of the apparatus 40, and connects sections of the entire apparatus 40 with various interfaces and lines.

In at least one embodiment, the memory 41 can be used to store program codes of computer readable programs and various data. The memory 41 can include a read-only memory (ROM), a random access memory (RAM), a programmable read-only memory (PROM), an erasable programmable read only memory (EPROM), a one-time programmable read-only memory (OTPROM), an electronically-erasable programmable read-only memory (EEPROM), a compact disc read-only memory (CD-ROM), or other optical disk storage, magnetic disk storage, magnetic tape storage, or any other storage medium readable by the apparatus 40.

In at least one embodiment, the apparatus 40 may be a computing device such as a desktop computer, a notebook, a palmtop computer, a cloud server, an ebook reader, a working station, a service station, a personal digital assistant (PDA), a portable multimedia player (PMP), a MP3 player, a portable medical equipment, a camera, or a wearable device. It should be noted that the apparatus 40 is merely an example, other existing or future electronic products may be included in the scope of the present disclosure and included in this reference. Components, such as the apparatus 40, may also include input and output devices, network access devices, buses, and the like.

A non-transitory computer-readable storage medium including program instructions for causing the apparatus to perform the method for augmenting defect sample data is also disclosed.

The present disclosure implements all or part of the processes in the foregoing embodiments, and a computer program may also instruct related hardware. The computer program may be stored in a computer readable storage medium. The steps of the various method embodiments described above may be implemented by a computer program when executed by a processor. Wherein, the computer program comprises computer program code, which may be in the form of source code, product code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM, Random Access Memory), electrical carrier signals, telecommunications signals, and software distribution media. It should be noted that the content contained in the computer readable medium may be increased or decreased according to the requirements of legislation and patent practice in a jurisdiction, for example, in some jurisdictions, computer-readable media does not include electrical carrier signals and telecommunication signals.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A method for optimizing generative adversarial network (GAN) comprising:
determining a first weight of a generator and a second weight of a discriminator, wherein the first weight is equal to the second weight, the first weight is configured to indicate a learning ability of the generator, the second weight is configured to indicate a learning ability of the discriminator; and
alternative iteratively training the generator and the discriminator until the generator and the discriminator are convergent.

2. The method according to claim 1, wherein the first weight and the second weight are in positive correlation.

3. The method according to claim 2, wherein the generator and the discriminator are both neural networks, the neural network includes at least one of convolutional neural networks (CNN), recurrent neural network (RNN) and deep neural networks (DNN).

4. The method according to claim 3, wherein the determining a first weight of a generator and a second weight of a discriminator by at least one of Xavier initialization, Kaiming initialization, Fixup initialization, LSUV initialization, and transfer learning.

5. The method according to claim 3, wherein the alternative iteratively training the generator and the discriminator further comprises:
training the generator and updating the first weight; and
training the discriminator and updating the second weight.

6. The method according to claim 5, wherein the updating of the first weight is related to a learning ratio and a loss function of the generator, the updating of the second weight is related to a learning ratio and a loss function of the discriminator.

7. The method according to claim 6, wherein the learning ratio is dynamically set according to training times.

8. The method according to claim 6, wherein the loss function of the generator is
$${L}_{g} = - {∇}_{{θ}_{g}} \frac{1}{m} {\sum }_{i = 1}^{m} log ( 1 - D ( G ( {z}^{( i )} ) ) )$$
wherein m means a quantity of the noise sample z⁽ⁱ⁾ means an ith noise sample; G(z⁽ⁱ⁾) means an image generated through the noise sample z⁽ⁱ⁾; D (G(z⁽ⁱ⁾)) means a probability of determining the image being true; θ_{g} means the first weight.

9. The method according to claim 8, wherein the loss function of the discriminator is
$${L}_{d} = {∇}_{{θ}_{d}} \frac{1}{m} {\sum }_{i = 1}^{m} [ log D ( {x}^{( i )} ) + log ( 1 - D ( G ( {z}^{( i )} ) ) ) ]$$
wherein x⁽ⁱ⁾ means an ith real image; D(x⁽ⁱ⁾) means a probability of determining the real image x⁽ⁱ⁾ being true; θ_{g} means the second weight.

10. An apparatus for optimizing generative adversarial network (GAN) comprising:
a memory;
at least one processor; and
the memory storing one or more programs that, when executed by the at least one processor, cause the at least one processor to perform:
determining a first weight of a generator and a second weight of a discriminator, wherein the first weight is equal to the second weight, the first weight is configured to indicate a learning ability of the generator, the second weight is configured to indicate a learning ability of the discriminator; and
alternative iteratively training the generator and the discriminator until the generator and the discriminator are convergent.

11. The apparatus according to claim 10, wherein the first weight and the second weight are in positive correlation.

12. The apparatus according to claim 11, wherein the generator and the discriminator are both neural networks, the neural network includes at least one of convolutional neural networks (CNN), recurrent neural network (RNN) and deep neural networks (DNN).

13. The apparatus according to claim 12, wherein the determining a first weight of a generator and a second weight of a discriminator by at least one of Xavier initialization, Kaiming initialization, Fixup initialization, LSUV initialization, and transfer learning.

14. The apparatus according to claim 12, wherein the alternative iteratively training the generator and the discriminator further comprises:
training the generator and updating the first weight; and
training the discriminator and updating the second weight.

15. The apparatus according to claim 14, wherein the updating of the first weight is related to a learning ratio and a loss function of the generator, the updating of the second weight is related to a learning ratio and a loss function of the discriminator.

16. The apparatus according to claim 15, wherein the learning ratio is dynamically set according to training times.

17. The apparatus according to claim 15, wherein the loss function of the generator is
$${L}_{g} = - {∇}_{{θ}_{g}} \frac{1}{m} {\sum }_{i = 1}^{m} log ( 1 - D ( G ( {z}^{( i )} ) ) )$$
wherein m means a quantity of the noise sample z; z⁽ⁱ⁾ means an ith noise sample; G(z⁽ⁱ⁾) means an image generated through the noise sample z⁽ⁱ⁾; D (G(z⁽ⁱ⁾)) means a probability of determining the image being true; θ_{g} means the first weight.

18. The apparatus according to claim 17, wherein the loss function of the discriminator is
$${L}_{d} = {∇}_{{θ}_{d}} \frac{1}{m} {\sum }_{i = 1}^{m} [ log D ( {x}^{( i )} ) + log ( 1 - D ( G ( {z}^{( i )} ) ) ) ]$$
wherein x⁽ⁱ⁾ means an ith real image; D(x⁽ⁱ⁾) means a probability of determining the real image x⁽ⁱ⁾ being true; θ_{d} means the second weight.

19. A non-transitory computer readable medium having stored thereon instructions that, when executed by a processor of an apparatus, causes the processor to perform a method for optimizing generative adversarial network (GAN), the method comprising:
determining a first weight of a generator and a second weight of a discriminator, wherein the first weight is equal to the second weight, the first weight is configured to indicate a learning ability of the generator, the second weight is configured to indicate a learning ability of the discriminator; and
alternative iteratively training the generator and the discriminator until the generator and the discriminator are convergent.
